(19) United States
(12) Patent Application Publication
(10) Pub. No.: US 2026/0302204 A1
(43) Pub. Date: Oct. 1, 2026

(54) SECONDARY BATTERY

(71) Applicant: SAMSUNG SDI CO., LTD., Yongin-si (KR)

(72) Inventors: Jae Dong YANG, Yongin-si (KR); Won Jun CHANG, Yongin-si (KR)

(21) Appl. No.: 19/298,533

(22) Filed: Aug. 13, 2025

(30) Foreign Application Priority Data
Mar. 28, 2025 (KR) 10-2025-0040101

(51) Int. Cl. H01M 4/525; H01M 4/36; H01M 4/58; H01M 4/583; H01M 10/052; H01M 10/0587; H01M 50/105; H01M 50/593; H01M 50/595

(52) U.S. Cl. CPC H01M 4/525; H01M 4/366; H01M 4/5825; H01M 4/583; H01M 10/052; H01M 10/0587; H01M 50/105; H01M 50/593; H01M 50/595

(57) ABSTRACT

A secondary battery that prevents deterioration in cell characteristics by improving the flatness of an electrode assembly. The secondary battery includes a first electrode assembly having a first step and a second electrode assembly having a second step. The first step of the first electrode assembly and the second step of the second electrode assembly are complementarily engaged with each other.

### CROSS-REFERENCE TO RELATED APPLICATION

The present application claims priority to and the benefit of Korean Patent Application No. 10-2025-0040101, filed on Mar. 28, 2025, in the Korean Intellectual Property Office, the entire disclosure of which is incorporated herein by reference.

### BACKGROUND

### 1. Field

Embodiments of the present disclosure relate to a secondary battery.

### 2. Description of Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

This Background section is for the general understanding of the background of the present disclosure, and therefore, it may contain information that does not constitute related (or prior) art.

### SUMMARY

The present disclosure provides a secondary battery that improves the flatness of an electrode assembly, thereby preventing deterioration in cell characteristics.

The present disclosure provides a secondary battery that suppresses deformation, side reactions, and plating that may occur in a highly expandable electrode plate, thereby enhancing cell performance.

Embodiments of the present disclosure provide a secondary battery including a first electrode assembly having a first step and a second electrode assembly having a second step. The first step of the first electrode assembly and the second step of the second electrode assembly are complementarily engaged with each other.

According to some embodiments, the first step and the second step may face each other along a horizontal direction.

According to some embodiments, the first electrode assembly may include a first upper side and a second upper side that is higher than the first upper side, and the second electrode assembly may include a first lower side and a second lower side that is higher than the first lower side. The first upper side and the first lower side may face each other in a vertical direction, and the second upper side and the second lower side may face each other in the vertical direction.

In some embodiments, wherein the first electrode assembly comprises a first upper side and a second upper side, the second upper side having a height greater than a height of the first upper side, wherein the second electrode assembly comprises a first lower side and a second lower side, the second lower side having a height greater than a height of the first lower side, and wherein the first upper side and the first lower side face each other along a vertical direction and the second upper side and the second lower side face each other along the vertical direction.

According to some embodiments, the first step may be defined between the first upper side and the second upper side, and the second step may be defined between the first lower side and the second lower side.

According to some embodiments, the interface between the first upper side and the first lower side may be lower than the interface between the second upper side and the second lower side.

In some embodiments, an interface between the first upper side and the first lower side has a height less than a height of an interface between the second upper side and the second lower side.

According to some embodiments, the interface between the second upper side and the second lower side may be higher than the interface between the first upper side and the first lower side.

In some embodiments, an interface between the second upper side and the second lower side has a height greater than a height of an interface between the first upper side and the first lower side.

According to some embodiments, each of the first step and the second step may be provided at the center of a corresponding one of the first electrode assembly and the second electrode assembly in a width direction.

In some embodiments, each of the first step and the second step is disposed at a center of a corresponding one of the first electrode assembly and the second electrode assembly along a horizontal direction.

According to some embodiments, each of the first step and the second step may be spaced apart from the center of a corresponding one of the first electrode assembly and the second electrode assembly in the width direction.

In some embodiments, each of the first step and the second step is spaced apart from a center of a corresponding one of the first electrode assembly and the second electrode assembly along a horizontal direction.

According to some embodiments, each of the first electrode assembly and the second electrode assembly may be of a wound type.

According to some embodiments, the first step of the first electrode assembly may be disposed at a position opposite a first winding trailing end of the first electrode assembly, and the second step of the second electrode assembly may be disposed at a position opposite a second winding trailing end of the second electrode assembly.

According to some embodiments, each of the first electrode assembly and the second electrode assembly may be formed by stacking and winding a first electrode plate and a second electrode plate with a separator interposed between the first and second electrode plates, and each of the first step and the second step may be formed by bending the first electrode plate, the second electrode plate, and the separator together in the last turn areas of the first electrode plate, the second electrode plate, and the separator.

In some embodiments, each of the first electrode assembly and the second electrode assembly is formed by stacking and winding a first electrode plate and a second electrode plate with a separator interposed between the first electrode plate and the second electrode plate, and wherein each of the first step and the second step is formed by bending the first electrode plate, the second electrode plate, and the separator together in a terminal turn area of each of the first electrode plate, the second electrode plate, and the separator.

According to some embodiments, the first and second electrode plates of each of the first and second electrode assemblies may include first and second substrates and first and second active material layers coated on the first and second substrates, respectively, and the first and second active material layers may not be coated in regions from the first and second steps to the first and second winding trailing ends.

In some embodiments, the first electrode plate of each of the first electrode assembly and the second electrode assembly comprise a first substrate and a first active material layer coated on the first substrate, wherein the second electrode plate of each of the first electrode assembly and the second electrode assembly comprise a second substrate and a second active material layer coated on the second substrate, wherein the first active material layer Is not coated in a region from the first step to the first winding trailing end, and wherein the second active material layer is not coated in a region from the second step to the second winding trailing end.

According to some embodiments, the first electrode assembly and the second electrode assembly may be of different types.

According to some embodiments, the first electrode plate of the first electrode assembly may include lithium cobalt oxide (LCO) as a first active material, the second electrode plate of the first electrode assembly may include silicon carbide (SiC) as a second active material, the first electrode plate of the second electrode assembly may include lithium iron phosphate (LFP) as a first active material, and the second electrode plate of the second electrode assembly may include graphite as a second active material.

According to some embodiments, a thickness variation of each of the first and second electrode assemblies in the horizontal width direction may range from about 50 μm to about 100 μm.

In some embodiments, a thickness variation of each of the first and second electrode assemblies along a horizontal direction ranges from about 50 μm to about 100 μm.

According to some embodiments, the first winding trailing end and the second winding trailing end may be finished with a first insulating tape and a second insulating tape, respectively.

In some embodiments, the first winding trailing end is finished with a first insulating tape and the second winding trailing end is finished with a second insulating tape.

According to some embodiments, the first electrode assembly and the second electrode assembly may be finished together with a common sealing tape.

According to some embodiments, the first and second electrode assemblies may be accommodated in a pouch-type laminate case.

In some embodiments, the first electrode assembly and the second electrode assembly are accommodated in a pouch-type laminate case.

According to some embodiments, the first and second electrode assemblies may be accommodated in a metal case.

In some embodiments, the first electrode assembly and the second electrode assembly are accommodated in a metal case.

According to some embodiments, the first electrode assembly and the second electrode assembly may differ from each other in at least one of thickness or width.

In some embodiments, the first electrode assembly and the second electrode assembly differ from each other with respect to thickness or width.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings:

FIG. 1 is a plan view showing a secondary battery according to embodiments of the present disclosure;

FIG. 2 is an exploded perspective view showing the secondary battery in FIG. 1 in a flipped state;

FIG. 3 is a rear perspective view showing an electrode assembly according to embodiments of the present disclosure;

FIG. 4 is a cross-sectional view showing before coupling of the electrode assemblies according to embodiments of the present disclosure;

FIG. 5 is a cross-sectional view showing after coupling of the electrode assemblies according to embodiments of the present disclosure;

FIG. 6 is a graph showing variation in the thickness of the electrode assembly along a width according to embodiments of the present disclosure;

FIG. 7 is a cross-sectional view showing before coupling of the electrode assemblies according to embodiments of the present disclosure;

FIG. 8 is a cross-sectional view showing after coupling of the electrode assemblies according to embodiments of the present disclosure;

FIG. 9 is an enlarged view of area 9 in FIG. 8;

FIG. 10 is a cross-sectional view showing a general electrode assembly according to embodiments of the present disclosure;

FIG. 11 is a graph showing variation in the thickness of the general electrode assembly along a width according to embodiments of the present disclosure;

FIG. 12 is a perspective view showing a secondary battery according to embodiments of the present disclosure;

FIG. 13 is a cross-sectional view showing a secondary battery according to embodiments of the present disclosure;

FIG. 14 is a perspective view showing a battery module according to embodiments of the present disclosure;

FIG. 15 is a perspective view showing a battery pack including the secondary battery according to embodiments of the present disclosure;

FIG. 16 is a perspective view showing a battery pack including the secondary battery according to embodiments of the present disclosure;

FIG. 17 is a perspective view showing a vehicle including aspects of a battery pack according to embodiments of the present disclosure; and

FIG. 18 is a side view showing a vehicle including aspects of a battery pack according to embodiments of the present disclosure.

### DETAILED DESCRIPTION

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

In general, the performance of a battery cell may be influenced by the flatness of an electrode plate. For example, in an electrode assembly manufactured in a wound form, the flatness of the electrode plate may be non-uniform, which may lead to deterioration in cell performance. A step generated in the electrode plate may deteriorate the adhesion of a separator, thereby causing side reactions and lithium plating. For example, if an electrode plate includes silicon rather than graphite, the expansion ratio of the electrode plate may increase, and thus the flatness of the electrode plate may become increasingly non-uniform.

In a conventional wound form, an electrode assembly is typically composed of a single electrode assembly, which leads to non-uniform flatness. This may cause deformation of the electrode assembly, side reactions, and plating during high-pressure compaction (HPC) and/or formation processes. The use of an electrode plate having a high silicon content may exacerbate such a deformation.

The present disclosure is directed to improving the flatness of an electrode assembly to prevent deterioration in cell characteristics, thereby suppressing deformation, various side reactions, and plating that may occur in a highly expandable electrode plate and enhancing cell performance.

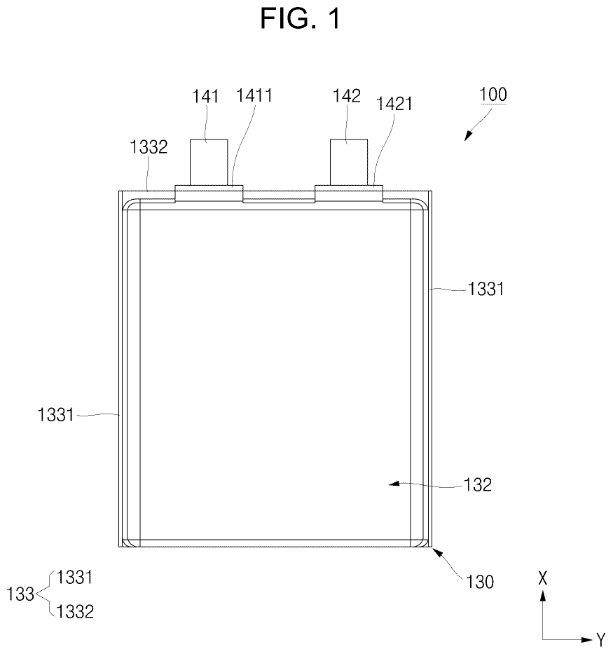

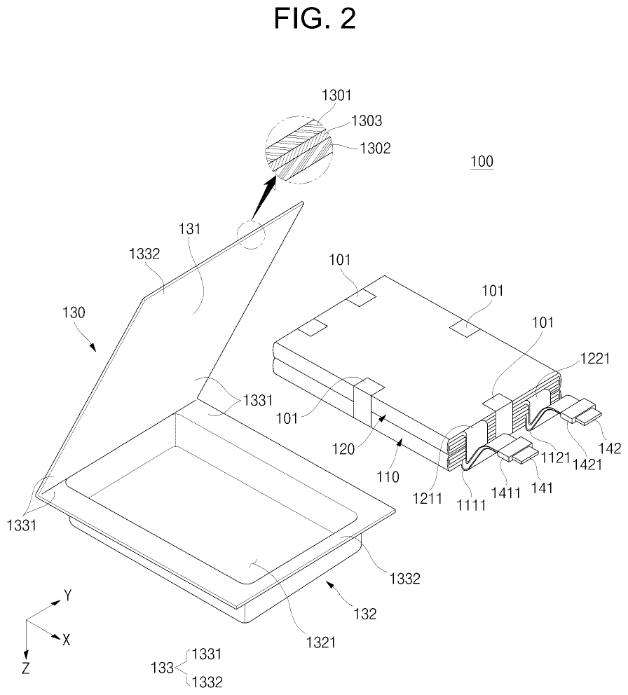

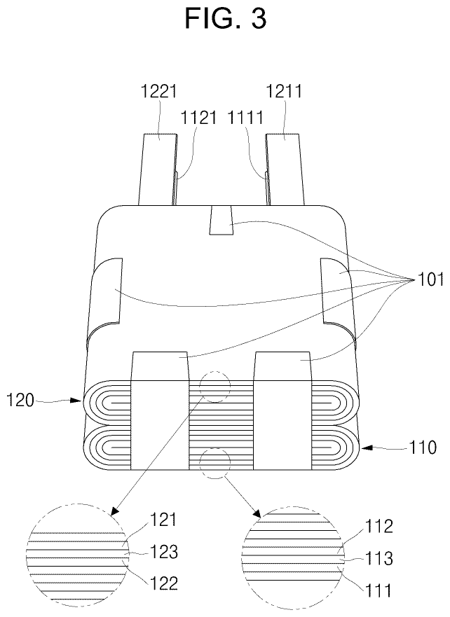

FIG. 1 is a plan view showing a secondary battery 100, FIG. 2 is an exploded perspective view showing the secondary battery 100 in FIG. 1 in a flipped state, and FIG. 3 is a rear perspective view showing an electrode assembly 110. Referring to FIGS. 1 to 3, the secondary battery 100 may include a first electrode assembly 110, a second electrode assembly 120, and a case 130. The secondary battery 100 may include a first electrode tab 141 and a second electrode tab 142, which extend from the interior of the case 130 to the exterior.

The first electrode assembly 110 and the second electrode assembly 120 may be substantially the same type or different types. For example, the first electrode assembly 110 and the second electrode assembly 120 may have substantially the same thicknesses and widths or have different thicknesses and widths. For convenience of description, the electrode assembly located at a lower position is defined as the first electrode assembly 110, and the electrode assembly located at an upper position is defined as the second electrode assembly 120. After the second electrode assembly 120 is placed on the first electrode assembly 110, the first and second electrode assemblies 110 and 120 may be fixed by a plurality of sealing tapes 101, whereby the first and second electrode assemblies 110 and 120 may be treated as a single electrode assembly.

The first electrode assembly 110 may include, for example, a wound-type electrode assembly. According to some embodiments, the first electrode assembly 110 may be formed by stacking a first electrode plate 111 and a second electrode plate 112 with a separator 113 interposed between the first and second electrode plates 111 and 112 and then winding the stacked assembly in a jelly-roll form. According to some embodiments, the first electrode plate 111 may include a first active material layer or a negative electrode active material layer, which is coated on one surface or both surfaces of a first substrate formed as a conductive metal thin plate, such as a copper or nickel foil or mesh. According to some embodiments, the first electrode plate 111 may operate as a negative electrode. According to some embodiments, the first substrate may include a first substrate tab 1111, which extends outward by a predetermined length without the first active material layer formed thereon, and the first substrate tab 1111 may be welded to the first electrode tab 141. According to some embodiments, a first uncoated portion (e.g., an area not coated with the first active material layer) may be connected to the first electrode tab 141 via a separate first strip terminal, rather than the first substrate tab 1111. The first substrate may include, or be referred to as, a first current collector or a first current-collecting plate. According to some embodiments, the second electrode plate 112 may include a second active material layer or a positive electrode active material layer, which is coated on both surfaces of a second substrate formed as a highly conductive metal thin plate, such as an aluminum foil or mesh. According to some embodiments, the second electrode plate 112 may operate as a positive electrode. According to some embodiments, the second substrate may include a second substrate tab 1121, which extends outward by a predetermined length without the second active material layer formed thereon, and the second substrate tab 1121 may be welded to the second electrode tab 142. According to some embodiments, a second uncoated portion may be connected to the second electrode tab 142 via a separate second strip terminal, rather than the second substrate tab 1121.

The second electrode assembly 120 may include, for example, a wound-type electrode assembly. According to some embodiments, the second electrode assembly 120 may be formed by stacking a first electrode plate 121 and a second electrode plate 122 with a separator 123 interposed between the first and second electrode plates 121 and 122 and then winding the stacked assembly. According to some embodiments, the first electrode plate 121 may include a first active material layer or a negative electrode active material layer, which is coated on one surface or both surfaces of a first substrate formed as a conductive metal thin plate, such as a copper or nickel foil or mesh. According to some embodiments, the first electrode plate 121 may operate as a negative electrode. According to some embodiments, the first substrate may include a first substrate tab 1211, which extends outward by a predetermined length without the first active material layer formed thereon, and the first substrate tab 1211 may be welded to the first electrode tab 141. According to some embodiments, a first uncoated portion (e.g., an area not coated with the first active material layer) may be connected to the first electrode tab 141 via a separate first strip terminal, rather than the first substrate tab 1211. The first substrate may include, or be referred to as, a first current collector or a first current-collecting plate. According to some embodiments, the second electrode plate 122 may include a second active material layer or a positive electrode active material layer, which is coated on both surfaces of a second substrate formed as a highly conductive metal thin plate, such as an aluminum foil or mesh. According to some embodiments, the second electrode plate 122 may operate as a positive electrode. According to some embodiments, the second substrate may include a second substrate tab 1221, which extends outward by a predetermined length without the second active material layer formed thereon, and the second substrate tab 1221 may be welded to the second electrode tab 142. According to some embodiments, a second uncoated portion may be connected to the second electrode tab 142 via a separate second strip terminal, rather than the second substrate tab 1221.

The first electrode tab 141 may be electrically connected to the first substrate tabs 1111 and 1211 of the first and second electrode assemblies 110 and 120 through an ultrasonic welding or laser welding method. The second electrode tab 142 may be electrically connected to the second substrate tabs 1121 and 1221 of the first and second electrode assemblies 110 and 120 through an ultrasonic welding or laser welding method.

According to some embodiments, the first electrode tab 141 and the second electrode tab 142 may extend outward by a predetermined length through the case 130, with first and second insulating tapes 1411 and 1421 interposed between the first and second electrode tabs 141 and 142 and the case 130, respectively.

The case 130 may accommodate the first and second electrode assemblies 110 and 120, and portions of the case 130 corresponding to outer sides of the first and second electrode assemblies 110 and 120 may be sealed. The case 130 may include, or be referred to as, a pouch case, an exterior member, a can, or a housing. According to some embodiments, the case 130 may have a laminated structure including, for example, a first insulating layer 1301, a second insulating layer 1302, and a metal layer 1303 interposed between the first and second insulating layers 1301 and 1302. According to some embodiments, the first insulating layer 1301 may include nylon or polyethylene terephthalate (PET), the metal layer 1303 may include an aluminum thin film, and the second insulating layer 1302 may include cast polypropylene (CPP). In some embodiments, various adhesive layers or functional layers may be added.

According to some embodiments, the case 130 may include a first case 131 and a second case 132, one side of which is connected to the first case 131 and which includes a recess 1321 having a predetermined depth to accommodate the first and second electrode assemblies 110 and 120. According to some embodiments, the peripheral regions of the first and second cases 131 and 132 corresponding to the outer sides of the first and second electrode assemblies 110 and 120 may be thermally fused to each other, thereby allowing the first and second electrode assemblies 110 and 120 to be accommodated in the case 130, which is configured as a substantially pouch-or pocket-type case. According to some embodiments, the thermally fused regions may be the second insulating layers 1302 of the first and second cases 131 and 132.

According to some embodiments, the case 130 may be divided into the first case 131 and the second case 132 by bending a substantially middle portion of the rectangular plate-shaped integrated case 130 in the longitudinal direction of one side thereof (e.g., an X-axis direction). The recess 1321 having a predetermined depth, in which the first and second electrode assemblies 110 and 120 may be accommodated, may be formed in the second case 132 through a pressing or drawing process, and a sealing area 133 for sealing with the first case 131 may be formed along the outer periphery of the recess 1321. According to some embodiments, the recess may be formed in the first case 131. The sealing area 133 may be formed along three sides of each of the first and second cases 131 and 132, except for one side thereof at which the first case 131 and the second case 132 are integrally connected to each other. According to some embodiments, the sealing area 133 may include a pair of lateral sealing portions 1331, which are provided by sealing the first and second cases 131 and 132 to each other in areas corresponding to the lateral sides of the first and second electrode assemblies 110 and 120 (e.g., areas outside the lateral sides of the first and second electrode assemblies 110 and 120), and a front sealing portion 1332, which is provided by sealing the first and second cases 131 and 132 to each other in an area corresponding to the front sides of the first and second electrode assemblies 110 and 120 (e.g., an area outside the front sides of the first and second electrode assemblies 110 and 120). FIG. 1 illustrates the pair of lateral sealing portions 1331 in a folded state, and FIG. 2 illustrates the pair of lateral sealing portions 1331 in a flat state before being folded. The lateral sealing portions 1331 may include, or be referred to as, wings or wing sealing areas. The front sealing portion 1332 may include, or be referred to as, a terrace or a terrace area.

According to some embodiments, the case 130 may include stainless steel. For example, sealing of stainless steel may be implemented through laser welding.

According to some embodiments, the first electrode tab 141 and the second electrode tab 142 may extend and protrude outside the case 130 through the front sealing portion 1332. For example, the first insulating tape 1411 and the second insulating tape 1421 may also be coupled to the front sealing portion 1332. According to some embodiments, the first electrode tab 141 may be made of copper or nickel, and the second electrode tab 142 may be made of aluminum. According to some embodiments, the electrode tab may include, or be referred to as, a lead, a lead tab, or a cell tab.

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery may move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

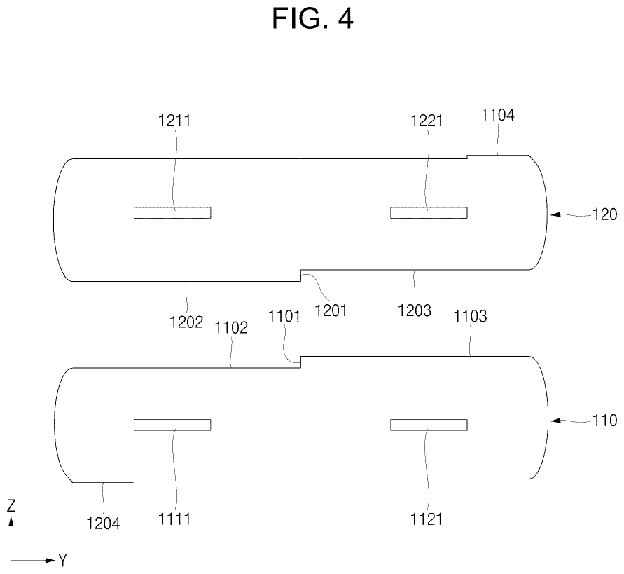

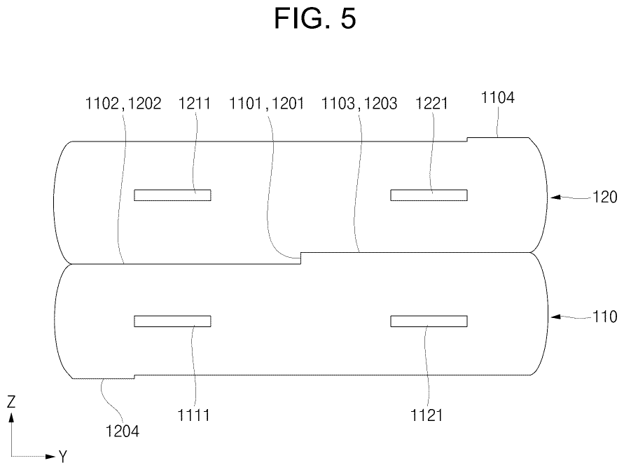

FIG. 4 is a cross-sectional view showing before coupling of the electrode assemblies, and FIG. 5 is a cross-sectional view showing after coupling of the electrode assemblies.

As shown in FIGS. 4 and 5, the first electrode assembly 110 may include a first step 1101, and the second electrode assembly 120 may include a second step 1201. The first step 1101 and the second step 1201 may be complementarily coupled to or engaged with each other, resulting in improvement in the flatness of the electrode assembly.

The first electrode assembly 110 may include a first upper side 1102 and a second upper side 1103, and the second electrode assembly 120 may include a first lower side 1202 and a second lower side 1203. The first upper side 1102 and the first lower side 1202 may face each other in a vertical direction (e.g., a Z-axis direction), and the second upper side 1103 and the second lower side 1203 may face each other in the vertical direction.

In one or more embodiments, the first step 1101 may be formed between the first upper side 1102 and the second upper side 1103, and the second step 1201 may be formed between the first lower side 1202 and the second lower side 1203. For example, the interface between the first upper side 1102 and the first lower side 1202 may be lower than the interface between the second upper side 1103 and the second lower side 1203. Conversely, the interface between the second upper side 1103 and the second lower side 1203 may be higher than the interface between the first upper side 1102 and the first lower side 1202.

In one or more embodiments, each of the first step 1101 and the second step 1201 may be provided substantially at the center of a corresponding one of the first electrode assembly 110 and the second electrode assembly 120 in a horizontal direction. In some embodiments, each of the first step 1101 and the second step 1201 may be spaced apart from the center of a corresponding one of the first electrode assembly 110 and the second electrode assembly 120 in the horizontal direction. The first step 1101 and the second step 1201 may face each other in a horizontal direction (e.g., a Y-axis direction).

In one or more embodiments, the first step 1101 of the first electrode assembly 110 may be provided at a position opposite a first winding trailing end 1104, and the second step 1201 of the second electrode assembly 120 may be provided at a position opposite a second winding trailing end 1204. For example, if the first step 1101 is provided on the upper side of the first electrode assembly 110, the first winding trailing end 1104 may be provided on the lower side of the first electrode assembly 110, and if the second step 1201 is provided on the lower side of the second electrode assembly 120, the second winding trailing end 1204 may be provided on the upper side of the second electrode assembly 120.

The first step 1101 of the first electrode assembly 110 and the second step 1201 of the second electrode assembly 120 may be complementarily coupled to or engaged with each other, whereby variation in the thickness of the electrode assembly in the horizontal direction may be minimized.

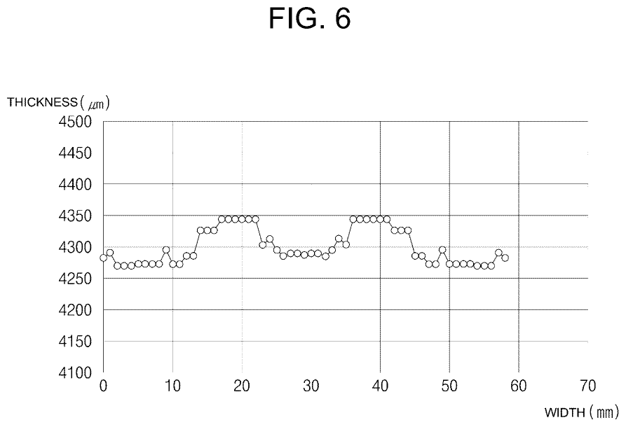

FIG. 6 is a graph showing variation in the thickness of the electrode assembly along a width from the left hand side of the electrode assembly to the right hand side of the electrode assembly. In FIG. 6, the horizontal axis represents the width (mm) from the left side of the electrode assembly to the right side of the electrode assembly, and the vertical axis represents the thickness (μm) of the electrode assembly. As shown in FIG. 6, the thickness of the electrode assembly may be distributed from about 4250 μm to about 4350 μm along the width from the left hand side of the electrode assembly to the right hand side of the electrode assembly.

In one or more embodiments, the thickness variation of the electrode assembly along the width thereof may be in the range of about 50 μm to about 100 μm. The electrode assembly may exhibit a reduced thickness variation along the width thereof, thereby preventing deformation of the electrode assembly, plating, or side reactions. As a result, cell stability and performance may be improved. By employing two electrode assemblies, it may be possible to independently design the respective electrode plates and separators, thereby increasing design flexibility.

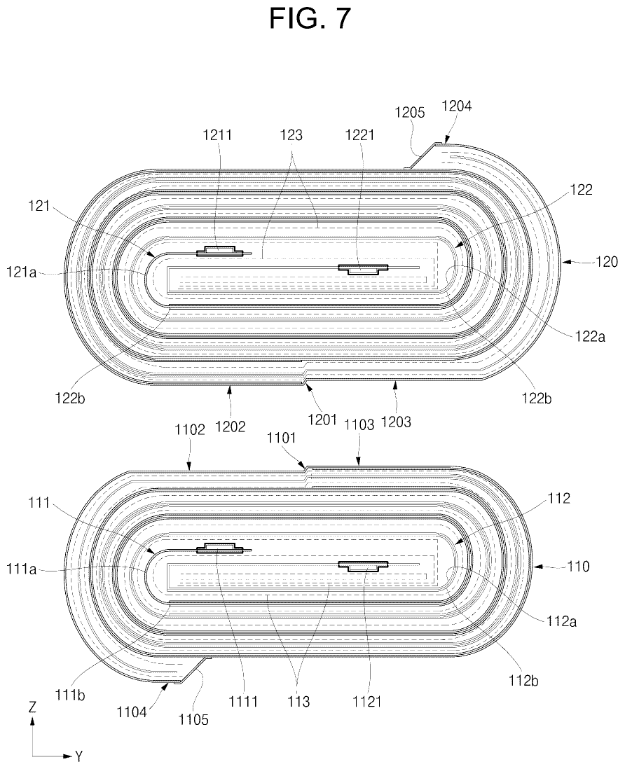

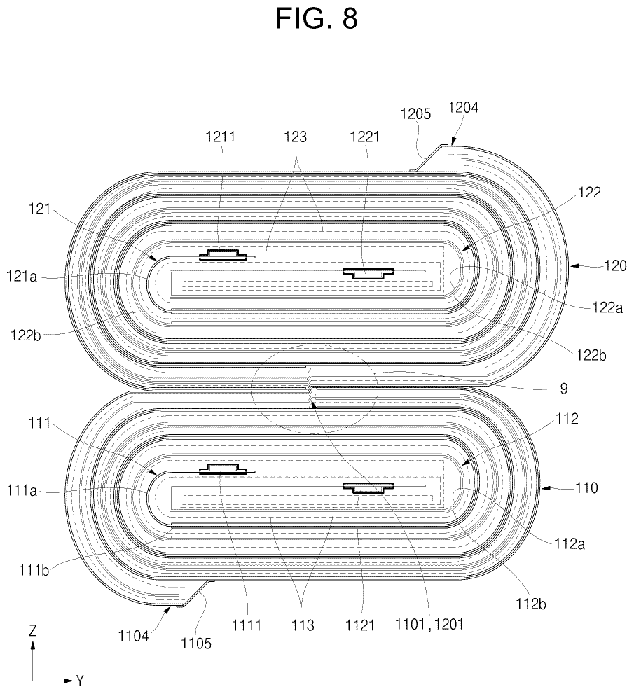

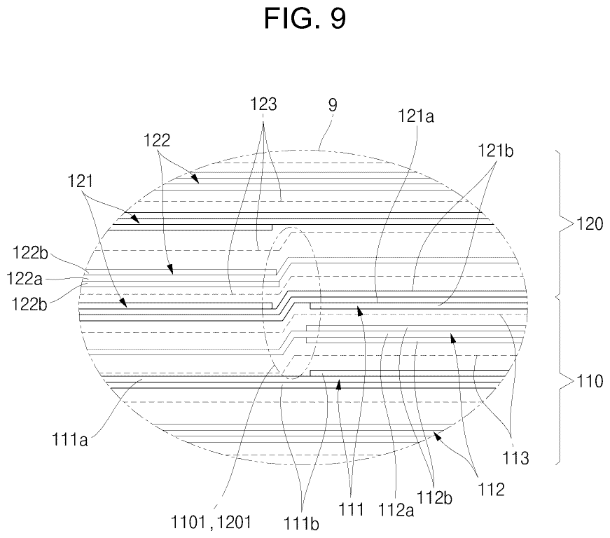

FIG. 7 is a cross-sectional view showing before coupling of the electrode assemblies, FIG. 8 is a cross-sectional view showing after coupling of the electrode assemblies, and FIG. 9 is an enlarged view of area 9 in FIG. 8. It should be understood that the sizes and shapes of the electrode assemblies are exaggerated in FIGS. 7 to 9 for convenience and clarity of description. Although the first electrode plate, the second electrode plate, and the separator interposed therebetween are illustrated in FIGS. 7 to 9 as being spaced apart from each other, these components may actually be in contact or in close contact with each other. It should be understood that the first electrode plate may be a negative electrode plate or a positive electrode plate and the second electrode plate may be a positive electrode plate or a negative electrode plate, respectively.

As shown in FIGS. 7 and 8, each of the first electrode assembly 110 and the second electrode assembly 120 may include a wound-type electrode assembly.

According to some embodiments, the first electrode assembly 110 may be formed by stacking the first electrode plate 111 and the second electrode plate 112 with the separator 113 interposed between the first and second electrode plates 111 and 112 and then winding the stacked assembly, and the first step 1101 may be formed by bending portions of the first electrode plate 111, the second electrode plate 112, and the separator 113 together in the last turn areas (e.g., the outermost areas) of the first electrode plate 111, the second electrode plate 112, and the separator 113.

According to some embodiments, the second electrode assembly 120 may be formed by stacking the first electrode plate 121 and the second electrode plate 122 with the separator 123 interposed between the first and second electrode plates 121 and 122 and then winding the stacked assembly, and the second step 1201 may be formed by bending portions of the first electrode plate 121, the second electrode plate 122, and the separator 123 together in the last turn areas (e.g., the outermost areas) of the first electrode plate 121, the second electrode plate 122, and the separator 123.

According to some embodiments, the first electrode plate 111 of the first electrode assembly 110 may include a first substrate 111a and a first active material layer 111b coated on the first substrate 111a, and the second electrode plate 112 of the first electrode assembly 110 may include a second substrate 112a and a second active material layer 112b coated on the second substrate 112a. The first and second active material layers 111b and 112b may not be coated in a region from the first step 1101 to the first winding trailing end 1104. For example, the first and second active material layers 111b and 112b may be coated on the first and second substrates 111a and 112a, respectively, in a region from the winding leading end to the first step 1101. However, the first and second active material layers 111b and 112b may not be coated on the first and second substrates 111a and 112a in a region from the first step 1101 to the first winding trailing end 1104. Thus, a portion of the electrode assembly on one side of the first step 1101 may have a relatively large thickness, and a portion of the electrode assembly on the opposite side of the first step 1101 may have a relatively small thickness. Due to this difference in thickness, the first step 1101 may be defined in the first electrode assembly 110.

According to some embodiments, the first electrode plate 121 of the second electrode assembly 120 may include a first substrate 121a and a first active material layer 121b coated on the first substrate 121a, and the second electrode plate 122 of the second electrode assembly 120 may include a second substrate 122a and a second active material layer 122b coated on the second substrate 122a. The first and second active material layers 121b and 122b may not be coated in a region from the second step 1201 to the second winding trailing end 1204. For example, the first and second active material layers 121b and 122b may be coated on the first and second substrates 121a and 122a, respectively, in a region from the winding leading end to the second step 1201. However, the first and second active material layers 121b and 122b may not be coated on the first and second substrates 121a and 122a in a region from the second step 1201 to the second winding trailing end 1204. Thus, a portion of the electrode assembly on one side of the second step 1201 may have a relatively large thickness, and a portion of the electrode assembly on the opposite side of the second step 1201 may have a relatively small thickness. Due to this difference in thickness, the second step 1201 may be defined in the second electrode assembly 120.

According to some embodiments, the thickness of the first substrate used in the first electrode assembly 110 or the second electrode assembly 120 may range from about 5 μm to about 30 μm, and the thickness of the first active material layer coated on the first substrate may range from about 10 μm to about 200 μm. According to some embodiments, the thickness of the second substrate used in the first electrode assembly 110 or the second electrode assembly 120 may range from about 5 μm to about 30 μm, and the thickness of the second active material layer coated on the second substrate may range from about 10 μm to about 200 μm. According to some embodiments, the thickness of the separator used in the first electrode assembly 110 or the second electrode assembly 120 may range from about 10 μm to about 25 μm. Due to the difference in thickness between the active material layer and the substrate (i.e., the active material layer being thicker than the substrate), a step may be naturally defined between a region in which both the active material layer and the substrate are present and a region in which only the substrate is present.

According to some embodiments, the first and second electrode assemblies 110 and 120 may be of substantially the same type or different types. According to some embodiments, the first electrode plate 111 of the first electrode assembly 110 may include, as the first active material, lithium cobalt oxide (LCO), nickel cobalt manganese (NCM), nickel cobalt aluminum (NCA), or lithium manganese oxide (LMO), and the second electrode plate 112 of the first electrode assembly 110 may include silicon carbide (SiC) as the second active material. According to some embodiments, the first electrode plate 121 of the second electrode assembly 120 may include lithium iron phosphate (LFP) as the first active material, and the second electrode plate 122 of the second electrode assembly 120 may include graphite as the second active material.

According to some embodiments, the first and second winding trailing ends 1104 and 1204 of the first and second electrode assemblies 110 and 120 may be respectively finished with first and second insulating tapes 1105 and 1205. The first and second electrode assemblies 110 and 120 may be finished together with a common sealing tape 101 (see FIG. 3).

The present disclosure provides a method of forming a cell by combining two electrode assemblies, rather than using a single electrode assembly. The two electrode assemblies may be structured to be engaged with each other and may have the same or different configurations. For example, the first electrode assembly 110 may include a positive electrode including an LCO active material and a negative electrode including a SiC active material, and the second electrode assembly 120 may include a positive electrode including an LFP active material and a negative electrode including a graphite (Gr) active material. This structure may address deformation and step-related issues of the electrode plates while maintaining the conventional structure in which two substrate tabs (or strip terminals) are welded to a single electrode tab.

In the improved structure of the electrode assembly according to the present disclosure, step formation may be mitigated by coupling two types of electrode assemblies to form a cell. As a result, the adhesion of the separator may be improved during a high-temperature and high-pressure formation process, and side reactions, lithium plating, and deformation that may occur due to electrolyte gathering in a stepped space may be prevented.

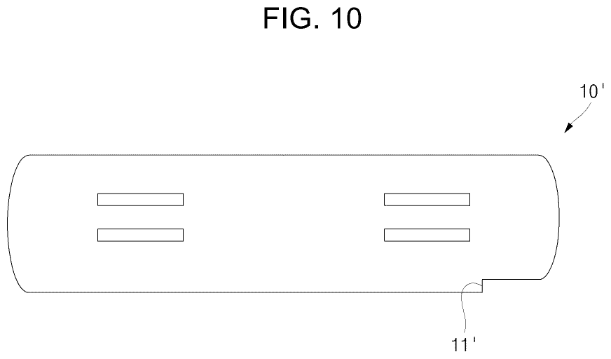

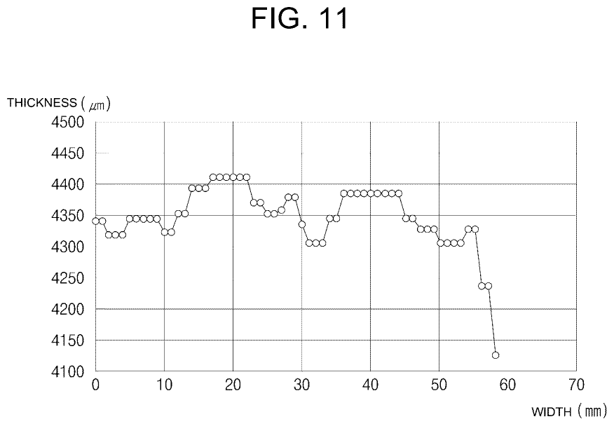

FIG. 10 is a cross-sectional view showing a general electrode assembly 10′, and FIG. 11 is a graph showing variation in the thickness of the general electrode assembly 10′ along a width from the left hand side of the general electrode assembly to the right hand side of the general electrode assembly. As shown in FIGS. 10 and 11, the general electrode assembly 10′ has low flatness because a step 11′ is directly exposed from the outer surface thereof. For example, the thickness of the general electrode assembly 10′ may be distributed between about 4100 μm and about 4400 μm.

The thickness difference between the thickest and thinnest portions of the general electrode assembly is about 289 μm. However, in the electrode assembly according to the present disclosure, the thickness difference may be reduced to about 75 μm, thereby eliminating abrupt thickness variation. As a result, in the electrode assembly according to the present disclosure, deformation, plating, and side reactions may be prevented, leading to improved cell stability and performance. Because two electrode assemblies are used, it may be possible to independently design the respective electrode plates and separators, thereby increasing design flexibility.

The present disclosure may improve the flatness of the electrode assembly, thereby preventing deterioration in performance of a battery cell and suppressing deformation and side reactions caused by using a highly expandable electrode plate including silicon. Because two types of electrode assemblies are coupled to form a cell, step-related issues may be resolved, and the stability and performance of the cell may be improved.

The present disclosure may be applied not only to the above-described pouch-type case or laminate-type battery but also to prismatic batteries.

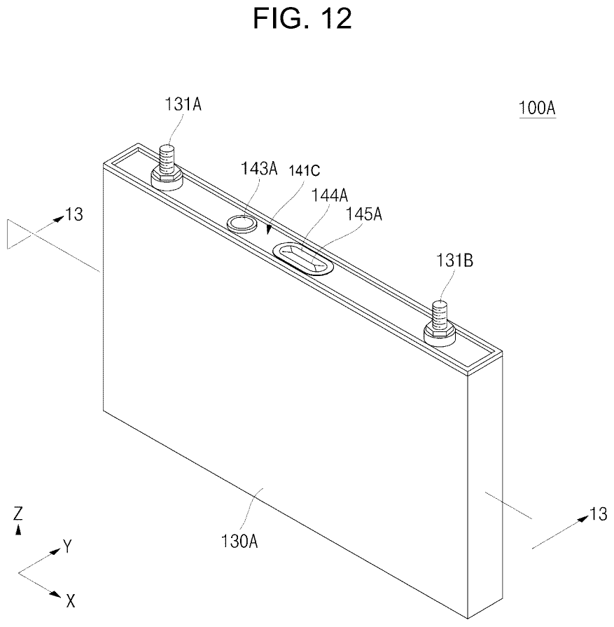

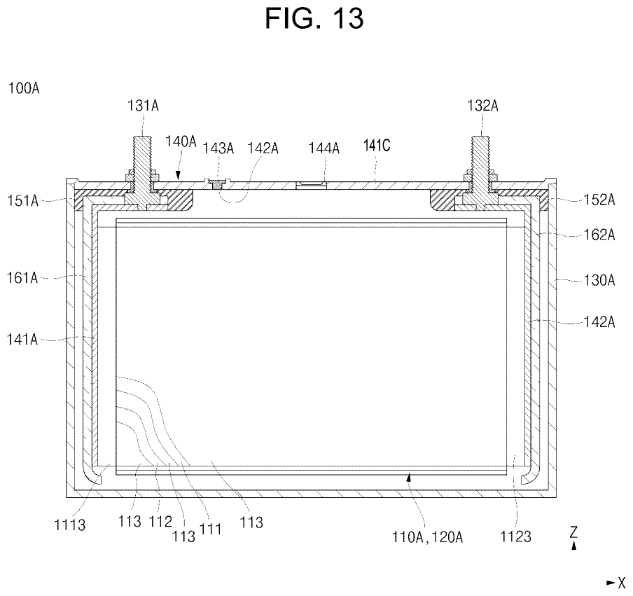

FIGS. 12 and 13 are, respectively, a perspective view and a cross-sectional view of a prismatic battery 100A. FIG. 13 is a cross-sectional view taken along line 13-13 in FIG. 12.

Referring to FIGS. 12 and 13, the secondary battery 100A may include first and second electrode assemblies 110A and 120A, a case 130A that accommodates the first and second electrode assemblies 110A and 120A, respectively, and a cap assembly 140A that seals an opening of the case 130A.

The first and second electrode assemblies 110A and 120A may be similar to those shown in FIGS. 2 to 5, 7, and 8. However, they differ in that first and second substrate tabs 1113 and 1123 protrude by a certain length in opposite directions along the winding axis. The first and second electrode assemblies 110A and 120A may be coupled to the case 130A with the winding axes oriented horizontally or vertically, rather than being mounted in a laid-down orientation, as shown in FIG. 13.

The case 130A may include a conductive metal, such as an aluminum alloy, nickel-plated steel, or stainless steel. The case 130A may provide a space in which the first and second electrode assemblies 110A and 120A are accommodated. According to some embodiments, the case 130A may have a flat hexahedral shape having an open top. According to some embodiments, the case 130A may include a pouch-type laminate exterior member or a pouch-type stainless steel exterior member as well as the prismatic case.

The cap assembly 140A may include a cap plate 141C that covers the opening of the case 130A. The material of the cap plate 141C may be similar or identical to that of the case 130A. A first terminal 131A and a second terminal 132A, which are electrically connected to the first electrode plates 111 and 121 and the second electrode plates 121 and 122, may be mounted to protrude outward through the cap plate 141C. The first terminal 131A may be referred to as a negative terminal, and the second terminal 132A may be referred to as a positive terminal.

According to some embodiments, threaded outer circumferential surfaces may be formed on upper portions of the first terminal 131A and the second terminal 132A protruding outside the cap plate 141C, and the first and second terminals 131A and 132A may be fastened to the cap plate 141C using nuts.

However, the present disclosure is not limited thereto, and the first terminal 131A and the second terminal 132A may be implemented in a rivet structure and coupled to the cap plate 141C by riveting, or may be welded to the cap plate 141C.

According to some embodiments, the cap plate 141C may be formed as a thin plate and may be coupled to the opening of the case 130A. The cap plate 141C may include an electrolyte injection hole 142A into which a sealing plug 143 may be mounted. A vent portion 144A in which a notch 134A is formed may be mounted to the cap plate 141C. In some examples, the vent portion 144A may seal a vent hole formed in the cap plate 141C. In some examples, the vent portion 144A may be bonded or welded to a peripheral region of the vent hole (i.e., region of the cap plate).

The first terminal 131A may be electrically connected to a first current collector 141A that is welded to the first substrate tab 1113. The second terminal 132A may be electrically connected to a second current collector 142A that is welded to the second substrate tab 1123.

The first terminal 131A may be welded to the first current collector 141A. However, the present disclosure is not limited thereto, and the first terminal 131A and the first current collector 141A may be integrally formed with each other. The second terminal 132A may be welded to the second current collector 142A. However, the present disclosure is not limited thereto, and the second terminal 132A and the second current collector 142A may be integrally formed with each other.

According to some embodiments, an insulating member may be mounted between the first and second electrode assemblies 110A and 120A and the cap plate 141C. The insulating member may include first and second lower insulating members 151A and 152A. The first and second lower insulating members 151A and 152A may be respectively mounted between the first and second electrode assemblies 110 and 120 and the cap plate 141C.

According to this embodiment, one end of a separation member may be mounted between the insulating member and each of the negative and positive terminals 131A and 132A so as to face one side surface of a respective one of the first and second electrode assemblies 110A and 120A.

According to some embodiments, the separation member may include first and second separation members 161A and 162A.

For example, one end of each of the first and second separation members 161A and 162A may be mounted between a respective one of the first and second lower insulating members 151A and 152A and a respective one of the first and second terminals 131A and 132A so as to face one side surface of a respective one of the first and second electrode assemblies 110A and 120A.

As a result, each of the first and second terminals 131A and 132A, which are welded to the first and second current collectors 141A and 142A, may be coupled to one end of a respective one of the first and second lower insulating members 151A and 152A and to one end of a respective one of the first and second separation members 161A and 162A.

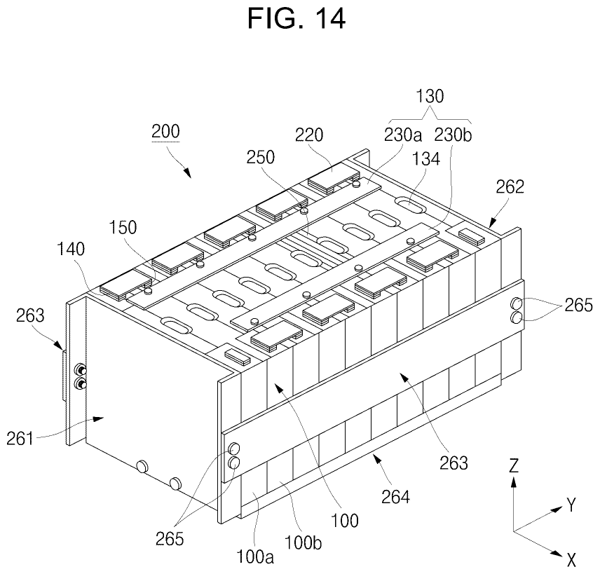

FIG. 14 is a perspective view showing a battery module 200. Referring to FIG. 14, the battery module 200 includes electrode portions 121A and 122A, a plurality of battery cells 100A arranged in one direction, a connection tab 220 connecting a battery cell 100a to an adjacent battery cell 100b, and a protection circuit module 230 having one end connected to the connection tab 220. The protection circuit module 230 may be a battery management system (BMS). In addition, the connection tab 220 includes a body portion that is in contact with the electrode portions 121A and 122A between neighboring battery cells 100a and 100b and an extension portion that extends from the body portion and is connected to the protection circuit module 230. The connection tab 220 may be a bus bar.

The battery cell 100A may include a battery case, an electrode stack housed in the battery case, and an electrolyte. The electrode stack and the electrolyte react electrochemically to generate energy. One side of the battery cell 100A may be provided with terminal portions 121A and 122A electrically connected to a connection tab 220, and a vent 134A as an exhaust passage for the gas that is generated internally. The terminals 121A and 122A of the battery cells 100A may be a negative electrode terminal 121A and a positive electrode terminal 122B having different polarities, and the terminals 121A and 122A of neighboring battery cells 100a and 100b may be electrically connected in series or in parallel by the connection tab 220. The description was given by way of example of a serial connection, but it is not limited to this structure, and various connection structures may be adopted as needed. In addition, the number and arrangement of battery cells are not limited to the structure shown in FIG. 19 and may be changed as needed.

A plurality of battery cells 100A may be arranged in one direction so that the wide-area surfaces of the battery cells 100A face each other, and the arranged plurality of battery cells 100A may be fixed by housings 261, 262, 263, and 264. The housings 261, 262, 263, and 264 may include a pair of end plates 261 and 262 facing the wide-area surfaces of the battery cell 100A, a side plate 263 connecting the pair of end plates 261 and 262, and a bottom plate 264. The side plate 263 may support the side surface of the battery cell 100A, and the bottom plate 264 may support the bottom surface of the battery cell 100A. In addition, the pair of end plates 261 and 262, the side plate 263, and the bottom plate 264 may be connected by means of a member, such as a bolt 265. In some examples, the bottom plate 264 may include or be referred to as a cooling plate.

The protection circuit module 230 mounts electronic components and protection circuits, and may be electrically connected to the connection tab 220 which will be described below. The protection circuit module 230 may include a first protection circuit module 230a and a second protection circuit module 230b extending at different locations along the direction in which the plurality of battery cells 100A are arranged, where the first protection circuit module 230a and the second protection circuit module 230b are positioned parallel to each other while being spaced apart from each other by a certain distance, and may be electrically connected to the connection tab 220 that is adjacent thereto, respectively. For example, the first protection circuit module 230a is formed to extend from one upper side of the plurality of battery cells 100A along the direction in which the plurality of battery cells 100A are arranged, and the second protection circuit module 230b is formed to extend from the other upper side of the plurality of battery cells 100A along the direction in which the plurality of battery cells 100A are arranged. Here, the second protection circuit module 230b is positioned to be spaced apart from the first protection circuit module 230a by a certain distance with the vent 134A interposed therebetween, but may be arranged parallel to the first protection circuit module 230a. In this way, the two protection circuit modules are arranged in parallel and spaced apart from each other along the direction in which a plurality battery cells are arranged, thereby minimizing the area of a printed circuit board (PCB) that constitutes the protection circuit module. By configuring the protection circuit module as two separate protection circuit modules, an unnecessary area of the PCM may be minimized. In addition, the first protection circuit module 230a and the second protection circuit module 230b may be connected to each other by a conductive connecting member 250. Here, one side of the connecting member 250 is connected to the first protection circuit module 230a, and the other side is connected to the second protection circuit module 230b, thereby achieving an electrical connection between the two protection circuit modules.

The connection may be performed by any one of soldering, resistance welding, laser welding, or projection welding.

In addition, the connecting member 250 may be, for example, an electric wire. In addition, the connecting member 250 may be made of a material having elasticity or flexibility. By means of the connecting member 250, the voltage, temperature, and current of the plurality of battery cells 100A may be checked and managed to be normal. That is, information such as voltage, current, and temperature received by the first protection circuit module from the connection tab that is adjacent thereto and information such as voltage, current, and temperature received by the second protection circuit module from the connection tab that is adjacent thereto may be integrated and managed by the protection circuit module through the connecting member.

In addition, when the battery cell 100A swells, the shock may be absorbed by the elasticity or flexibility of the connecting member 250, thereby preventing the first and second protection circuit modules 230a and 230b from being damaged. In addition, the shape or structure of connecting member 250 are not limited to that shown in FIG. 19.

In this manner, because the protection circuit module 230 includes the first and second protection circuit modules 230a and 230b, the area of the PCB constituting the protection circuit module may be minimized, thereby securing a space inside the battery module. This improves work efficiency by facilitating repair when an abnormality is detected in the battery module as well as a fastening work of connecting the connection tab 220 and the protection circuit module 230.

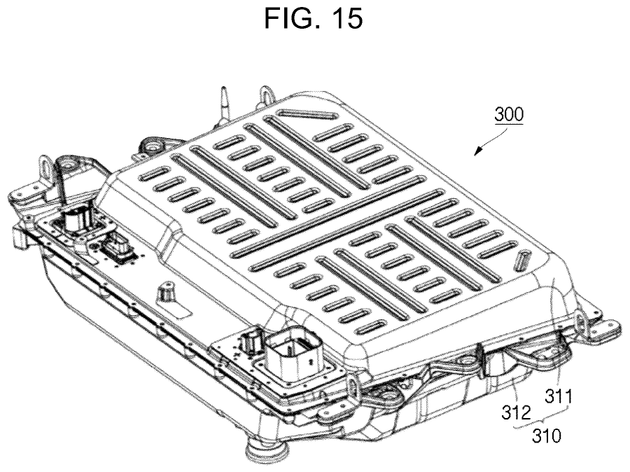

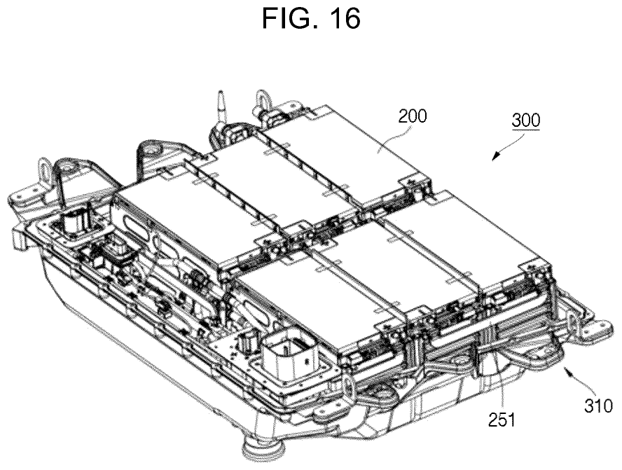

FIGS. 15 and 16 are perspective views showing a battery pack 300 including the secondary battery. Referring to FIGS. 15 and 16, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In FIGS. 15 and 16, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

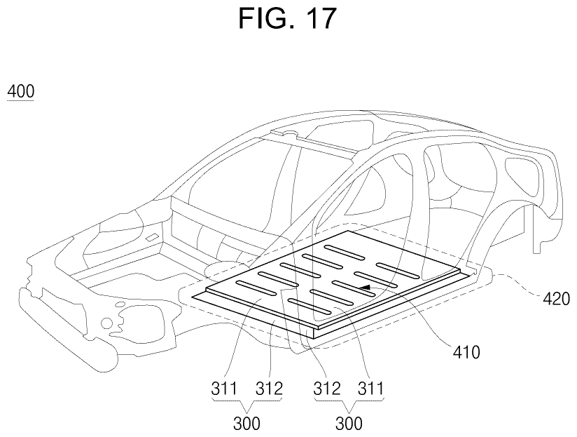

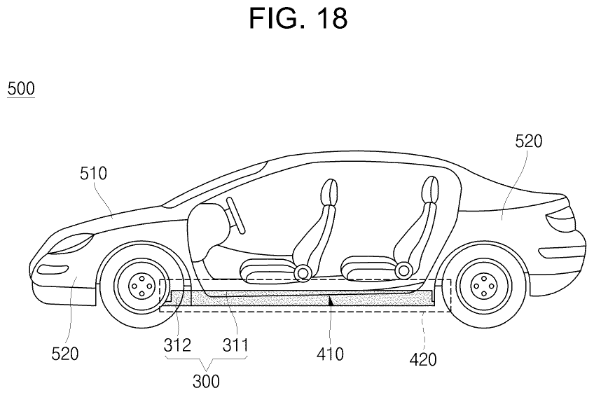

FIGS. 17 and 18 are perspective and side views showing vehicles 400 and 500 including the battery pack 300. In FIG. 17, a battery pack 300 may include a battery pack cover 311 (may correspond to the first housing above), which is a part of a vehicle underbody 410, and a pack frame 312 (may correspond to the second housing above) located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

In FIG. 18, a vehicle 500 may be formed by combining additional parts, such as a hood 510 in front of the vehicle and fenders 520 respectively located in the front and rear of the vehicle to vehicle body parts 400. The vehicle 500 may further include a vehicle floor 420, which is one of the vehicle body parts 400 including the battery pack 300 including the pack frame 312 and the battery pack cover 311.

As is apparent from the description, in the improved structure of the electrode assembly according to the present disclosure, step formation may be mitigated by coupling two types of electrode assemblies to form a cell. As a result, the adhesion of the separator may be improved during a high-temperature and high-pressure formation process, and side reactions, lithium plating, and deformation that may occur due to electrolyte gathering in a stepped space may be prevented.

Conventionally, the thickness difference between the thickest and thinnest portions of an electrode assembly is about 289 μm. However, in the electrode assembly according to the present disclosure, the thickness difference may be reduced to about 75 μm, thereby eliminating abrupt thickness variation. As a result, deformation of the electrode assembly, plating, and side reactions may be prevented, leading to improved cell stability and performance. By employing two separate electrode assemblies, it may be possible to independently design the respective electrode plates and separators, thereby increasing design flexibility.

Embodiments of the present disclosure may improve the flatness of the electrode assembly, thereby preventing deterioration in performance of a battery cell and suppressing deformation and side reactions caused by using a highly expandable electrode plate including silicon. Because different types of electrode assemblies are coupled to form a cell, step-related issues may be resolved, and the stability and performance of the cell may be improved.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery comprising:
a first electrode assembly having a first step; and
a second electrode assembly having a second step,
wherein the first step of the first electrode assembly and the second step of the second electrode assembly are complementarily engaged with each other.

2. The secondary battery as claimed in claim 1, wherein the first step and the second step face each other along a horizontal direction.

3. The secondary battery as claimed in claim 1, wherein the first electrode assembly comprises a first upper side and a second upper side, the second upper side having a height greater than a height of the first upper side, wherein the second electrode assembly comprises a first lower side and a second lower side, the second lower side having a height greater than a height of the first lower side, and wherein the first upper side and the first lower side face each other along a vertical direction and the second upper side and the second lower side face each other along the vertical direction.

4. The secondary battery as claimed in claim 3, wherein the first step is defined between the first upper side and the second upper side, and wherein the second step is defined between the first lower side and the second lower side.

5. The secondary battery as claimed in claim 3, wherein an interface between the first upper side and the first lower side has a height less than a height of an interface between the second upper side and the second lower side.

6. The secondary battery as claimed in claim 3, wherein an interface between the second upper side and the second lower side has a height greater than a height of an interface between the first upper side and the first lower side.

7. The secondary battery as claimed in claim 1, wherein each of the first step and the second step is disposed at a center of a corresponding one of the first electrode assembly and the second electrode assembly along a horizontal direction.

8. The secondary battery as claimed in claim 1, wherein each of the first step and the second step is spaced apart from a center of a corresponding one of the first electrode assembly and the second electrode assembly along a horizontal direction.

9. The secondary battery as claimed in claim 1, wherein each of the first electrode assembly and the second electrode assembly is of a wound type.

10. The secondary battery as claimed in claim 1, wherein the first step of the first electrode assembly is disposed at a position opposite a first winding trailing end of the first electrode assembly, and wherein the second step of the second electrode assembly is dispose at a position opposite a second winding trailing end of the second electrode assembly.

11. The secondary battery as claimed in claim 10, wherein each of the first electrode assembly and the second electrode assembly is formed by stacking and winding a first electrode plate and a second electrode plate with a separator interposed between the first electrode plate and the second electrode plate, and wherein each of the first step and the second step is formed by bending the first electrode plate, the second electrode plate, and the separator together in a terminal turn area of each of the first electrode plate, the second electrode plate, and the separator.

12. The secondary battery as claimed in claim 11, wherein the first electrode plate of each of the first electrode assembly and the second electrode assembly comprise a first substrate and a first active material layer coated on the first substrate, wherein the second electrode plate of each of the first electrode assembly and the second electrode assembly comprise a second substrate and a second active material layer coated on the second substrate, wherein the first active material layer Is not coated in a region from the first step to the first winding trailing end, and wherein the second active material layer is not coated in a region from the second step to the second winding trailing end.

13. The secondary battery as claimed in claim 12, wherein the first electrode assembly and the second electrode assembly are of different types.

14. The secondary battery as claimed in claim 12, wherein the first electrode plate of the first electrode assembly comprises lithium cobalt oxide as a first active material, wherein the second electrode plate of the first electrode assembly comprises silicon carbide as a second active material, wherein the first electrode plate of the second electrode assembly comprises lithium iron phosphate as a first active material, and wherein the second electrode plate of the second electrode assembly comprises graphite as a second active material.

15. The secondary battery as claimed in claim 1, wherein a thickness variation of each of the first and second electrode assemblies along a horizontal direction ranges from about 50 μm to about 100 μm.

16. The secondary battery as claimed in claim 10, wherein the first winding trailing end is finished with a first insulating tape and the second winding trailing end is finished with a second insulating tape.

17. The secondary battery as claimed in claim 1, wherein the first electrode assembly and the second electrode assembly are finished together with a common sealing tape.

18. The secondary battery as claimed in claim 1, wherein the first electrode assembly and the second electrode assembly are accommodated in a pouch-type laminate case.

19. The secondary battery as claimed in claim 1, wherein the first electrode assembly and the second electrode assembly are accommodated in a metal case.

20. The secondary battery as claimed in claim 1, wherein the first electrode assembly and the second electrode assembly differ from each other with respect to thickness or width.
